(19) United States
(12) Patent Application Publication
(10) Pub. No.: US 2020/0175787 A1
(43) Pub. Date: Jun. 4, 2020

(54) METHOD AND DEVICE IN A VEHICLE FOR EVALUATING AND STORING DATA

(71) Applicant: Robert Bosch GmbH, Stuttgart (DE)

(72) Inventor: Nikolaos Gortsas, Sindelfingen (DE)

(21) Appl. No.: 16/633,070

(22) PCT Filed: May 24, 2018
(86) PCT No.: PCT/EP2018/063637

§ 371 Date: Jan. 22, 2020

(30) Foreign Application Priority Data
Jul. 25, 2017 (DE) 10 2017 212 695.7

(51) Int. Cl. G07C 5/08; G07C 5/10; B60W 60/00; B60R 21/01; G06F 12/14; H04L 12/40

(52) U.S. Cl. CPC G07C 5/085; G07C 5/10; B60W 60/0059; B60R 21/01; H04L 2012/40273; H04L 12/40; B60R 2021/01068; G06F 2211/004; G06F 12/1491

(57) ABSTRACT

A device and a method in a vehicle which is controlled in autonomous or highly-automated driving mode without intervention of the driver or in a manual driving mode by the driver of the vehicle, the device evaluating and storing data, and the device including a memory unit, in which data are recorded which at least include pieces of information about whether the autonomous or highly-automated driving mode was active or the manual driving mode was active at a collision point in time or up to shortly before the collision point in time. Sensor signals from driver-actuatable operating elements and from collision recognition units are evaluated.

### FIELD

The present invention relates to a device and a method in a vehicle, which is controlled in an autonomous or highly-automated driving mode without intervention of the driver or in a manual driving mode by the driver of the vehicle, the device evaluating and storing data, and the device including a memory unit, in which data are recorded, which at least include pieces of information as to whether the autonomous or highly-automated driving mode was active or the manual driving mode was active at a collision point in time or up to shortly before the collision point in time. Sensor signals of driver-actuatable operating elements and of collision recognition units are evaluated.

### BACKGROUND INFORMATION

A method and a device for recording data which reflect parameters detected with the aid of sensors in a vehicle, in particular for reconstructing accidents, and a memory unit and a device for recording such data, are described in German Patent Application No. DE 100 46 696 A1. All relevant data are continuously recorded with low storage volume and permanently stored in a short time span. For this purpose, the parameter values and/or data computed therefrom are recorded with decreasing density with increasing time interval in relation to the present detection point in time.

### SUMMARY

In accordance with the present invention, an example device for vehicles is provided that may drive in a highly-automated or autonomous driving mode and include a memory unit in which it is stored whether, at a collision point in time or shortly before this collision point in time, the highly-automated or autonomous driving mode was active or the vehicle was manually controlled by the driver at this point in time. Advantageous refinements and designs of the present invention are described herein.

A highly-automated driving mode or an autonomous driving mode is understood to mean that the driver lets the vehicle drive independently through the traffic events and the driver does not intervene directly in the vehicle controller to control the vehicle. The driver takes over a control function and is available for taking over the system in the case where the vehicle controller is not able to manage the presently impending driving situation in the highly-automated driving mode. In the case of an autonomously controlled vehicle, even this control function by the driver may be omitted, so that the vehicle drives completely independently. Such a differentiation is also known, respectively, for example, as SAE level 4 or SAE level 5.

A manual driving mode is provided, in contrast, if the driver alone controls the vehicle himself or has activated a driver assistance system, which does accept driving tasks, but does not relieve the driver from his monitoring and control function. Driver assistance systems are frequently also designed in such a way that only parts of the driving task are taken over by the driver assistance system and the remaining tasks of the vehicle control still have to be fulfilled by the driver himself.

It is advantageously provided that the sensors, whose sensor signals are supplied, and may recognize whether the driver actuates driver-actuatable operating elements of the vehicle, are a steering wheel sensor, an accelerator pedal sensor, a brake pedal sensor, a clutch sensor, or an arbitrary combination of these sensors. The operating elements of the vehicle, which are directly required for a manual vehicle control, are monitored with the aid of one or multiple of these sensors. If these operating elements are actuated by the driver, it may thus be concluded therefrom that a manual driving mode is provided or the driver ends the autonomous or highly-automated driving mode and takes over by manual control. If these operating elements are not actuated by the driver over a longer period of time and instead an autonomous or highly-automated driving mode is activated, it may thus be concluded that the driver does not wish to take over the direct manual driving task.

Furthermore, it is advantageous that the collision recognition signals supplied to the device, with the aid of which it is recognized whether an accident of the vehicle has taken place or is imminent, are either signals from an airbag control device, which prompt freezing of the present data in the memory unit upon triggering or partial triggering of the airbag, or are signals from a surroundings sensor having collision recognition, which prompt freezing of the present data in the memory unit upon detection of a collision situation which is no longer avoidable, or is a combination of these two options.

Alternatively or in combination with the evaluation of the airbag triggering signals, the vehicle may evaluate data from at least one surroundings sensor. Such surroundings sensors are, for example, radar, LIDAR, video, or ultrasound sensors and may evaluate an approach of the ego vehicle to other objects, it being able to be established whether this approach to objects results in a critical traffic situation which even results in a collision that is no longer avoidable. If the vehicle has such a surroundings sensor and such an evaluation function, if a critical driving situation or a collision situation that is no longer avoidable is recognized, freezing of the data may already take place before the collision point in time.

If the airbags of the vehicle are triggered, a collision has thus already taken place, so that the presently provided data are to be stored for a later accident evaluation. The storage of the data has to take place in such a way that a subsequent manipulation of these data is no longer possible. Such securing of the data against deletion, overwriting, or modification is referred to within the scope of the present invention as freezing of the data.

Furthermore, it is advantageous that the memory unit is designed as a ring buffer. A ring buffer is in this case a memory unit in which the data are written continuously into the memory. If the memory content is completely filled, the oldest stored data are thus overwritten again with present data. In this way, the most up-to-date data are always provided, and older data which are no longer required are automatically overwritten.

It is advantageously provided that the evaluation unit, the sensors, the collision recognition unit, the memory, or parts of these components are connected to one another with the aid of a communication bus. Contemporary vehicles include multiple different communication buses which connect different vehicle components and control devices to one another. The use of such communication buses for implementing the device according to the present invention may be advantageous, since the expenditure for implementing the device may be reduced. It may also be advantageous to implement the device according to the present invention in multiple different vehicle components, in order to nonetheless keep it functional in case of a vehicle collision in which the vehicle components are destroyed.

Furthermore, it is advantageous that the timers in the evaluation unit, in the sensors, in the collision recognition unit, and in the memory are synchronized with one another via the communication bus. Presently, clock generators are equipped or internal clocks are installed without exception in electronic devices which communicate with one another. In the case of the use of internal clocks, the transmitted data may also be provided with a timestamp. In the case of the operation of a bus system having multiple components, it is advantageous if the components connected thereto operate with a synchronized clock pulse or, in the case of internal clocks, these clocks are synchronized with one another. In particular, in the case of the implementation of the present invention in multiple control devices and electronic components, it is advantageous to synchronize the pulse generators and/or internal clocks to improve a later accident reconstruction.

Furthermore, it is advantageous that the data stored in the memory unit are stored with a timestamp. In this way, it is possible to be able to perform an accident reconstruction with very precise timeline.

Furthermore, it is advantageous that the sensors which recognize whether the driver actuates driver-actuatable operating elements of the vehicle are designed as a steering wheel sensor, as an accelerator pedal sensor, as a brake pedal sensor, as a clutch sensor, or as an arbitrary combination of these sensors. Furthermore, it is advantageous that the pieces of information stored in the memory unit, which indicate whether the autonomous or highly-automated driving mode was active or the manual driving mode was active at a collision point in time or up to shortly before a collision point in time is mapped as a status bit. The information as to whether the vehicle drove independently or the driver controlled the vehicle may be stored, for example, with the aid of a special status bit in the memory unit. Due to the use of a status bit, it is possible to implement this information with the least possible memory requirement. If this status bit is stored with a high time resolution in the ring buffer, possibly with addition of a timestamp signal, it may thus be established very accurately in an accident reconstruction after a collision has occurred at which point in time the driver took over the vehicle control and at which point in time the highly-automated control system of the vehicle requested the driver takeover. The less memory requirement this information occupies, the more frequently may this information be stored and the higher resolution the time reconstruction will be in the case of a readout. The use of a status bit has proven to be particularly effective for this purpose.

Furthermore, it is advantageous that at least the status bit and the timestamp are stored when the autonomous or highly-automated driving mode is started and/or the autonomous or highly-automated driving mode is ended and/or the vehicle outputs the message to the driver during the autonomous or highly-automated driving mode that the driver should take over the control of the vehicle and/or the driver actuates one or more driver-actuatable operating elements and/or a collision recognition signal is recognized, that an accident of the vehicle has taken place or an accident of the vehicle is imminent and/or an arbitrary combination of the listed events.

The implementation of an example embodiment of the method according to the present invention in the form of a control element, which is provided for a control device of a highly-automated vehicle control or an autonomous vehicle control of a motor vehicle, is of particular significance. A program is stored on the control element that may be run on a computer, in particular on a microprocessor or a signal processor, which is capable of executing the method according to the present invention. In this case, the present invention is thus implemented by a program stored on the control element, so that this control element provided with the program represents the present invention in the same way as the method, which the program is capable of executing.

Further features, possible applications, and advantages of the present invention result from the following description of exemplary embodiments of the present invention, which are shown in the figures. All features which are described or shown form the subject matter of the present invention in and of itself or in any arbitrary combination, regardless of their formulation or representation in the description or in the figures, respectively.

### BRIEF DESCRIPTION OF THE DRAWINGS

Exemplary embodiments of the present invention are explained hereafter on the basis of the figures.

FIG. 1 shows a schematic block diagram of one specific embodiment of the device according to the present invention.

FIG. 2 shows a schematic block diagram of the evaluation unit of the device according to the present invention.

FIG. 3 shows an illustration of a timeline which reflects an exemplary driving situation.

FIG. 4 shows a schematic flow chart to explain the method according to the present invention.

### DETAILED DESCRIPTION OF EXAMPLE EMBODIMENTS

In FIG. 1, a communication bus 1, which connects multiple components to one another, is shown at the lower end by the horizontal bar. This communication bus 1 may be designed, for example, as a CAN bus. A control device 2 for the sensor evaluation, in which the method according to the present invention runs, for example, is connected to this CAN bus. Furthermore, different sensors are connected to communication bus 1. Thus, for example, a steering wheel sensor 3, an accelerator pedal sensor 4, a brake pedal sensor 5, and a clutch sensor 6 are indicated. These sensors are also connected to communication bus 1. In the case in which the vehicle includes an automatic transmission, the clutch sensor may be omitted. Alternatively, sensors 3 through 6 may also be directly connected to control unit 2 for the sensor evaluation. Furthermore, a further control device 7 is shown in FIG. 1, which may optionally be provided and is therefore shown by dashed lines in FIG. 7 and may be designed as an airbag control device. If a collision occurs, airbag triggering is thus ascertained with the aid of acceleration sensors. Collision recognition unit 7 may recognize a collision which has occurred by the evaluation of this deceleration signal or the impact signal and may relay this detection signal via communication bus 1 to control device 2 for sensor evaluation. Alternatively, it is also possible that collision recognition unit 7 is a surroundings sensor, which detects the vehicle surroundings and recognizes a critical approach of an object to the ego vehicle. In this case, the collision recognition unit would be designed as a component of control device 8 for autonomous or highly-automated driving. This control device 8 for autonomous or highly-automated driving receives pieces of information from the surroundings sensor of the vehicle and may recognize an imminent and possibly unavoidable collision situation and may replace optionally provided airbag control device 7, since then collision recognition unit 7 is designed as an integral component of control device 8. By way of such an evaluation of surroundings detection means, it is possible to recognize even before a collision has occurred that an unavoidable collision is imminent. In the case in which such a critical approach is recognized, or an unavoidable collision is imminent, a signal may also be transmitted via communication bus 1 to control device 2 for the sensor evaluation by the evaluation device of the surroundings sensor, which in this case is control device 8 for autonomous or highly-automated driving and assumes the function of collision recognition unit 7.

Furthermore, above-mentioned control device 8 for autonomous driving or highly-automated driving is shown. In the case in which this control device 8 for highly-automated or autonomous driving is connected to communication bus 1, the evaluation of the surroundings sensor by collision recognition unit 7 may be omitted and instead it may be executed by the control device for autonomous driving designed as a head unit. It may be detected with the aid of steering wheel sensor 3 whether the driver has his hands on the steering wheel or a steering activity of the driver exists. It may be detected with the aid of accelerator pedal sensor 4 whether the driver actuates the accelerator pedal. It may be detected with the aid of brake pedal sensor 5 whether the driver actuates the brake pedal and thus intends to end the autonomous or highly-automated driving mode and intends to take over the vehicle control manually again. It may be detected with the aid of optional clutch sensor 6 whether the driver actuates the clutch pedal and thus intends to end an autonomous driving mode or highly-automated driving mode and to continue to manually control the vehicle himself. Control device 2 is connected directly or via a communication bus 1 to sensors 3, 4, 5, 6.

Control device 2 processes the sensor signals and derives therefrom whether the driver intervenes in the driving actions by actuating either the steering wheel or a pedal. This piece of information may be mapped, for example, on a status bit, which is stored and represents whether the driver intervenes in the driving actions. In addition to this piece of information, the point in time of the intervention is also to be accurately documented. It is advantageous if, on the one hand, it is detected whether the driver intervenes in the driving actions or not, and also at which point in time A the driver possibly intervenes in the driving actions. These pieces of information are stored in a memory unit, in particular a ring buffer, which may be designed, for example, as part of control device 2 for the sensor evaluation. This memory unit may alternatively also be installed at another point in the vehicle and may be connected via communication bus 2. Furthermore, it is possible that this memory unit is situated outside the vehicle and the data to be stored are transmitted by control device 2 via communication bus 1 to a radio interface, from which these signals to be stored are transmitted into a data cloud provided outside the vehicle.

Control device 2 receives, via communication bus 1 from control device 8 responsible for the autonomous driving or the highly-automated driving, the piece of information as to whether the vehicle is presently controlled by the automatic vehicle controller. For this purpose, in addition to the status bit which represents whether or not driving is presently carried out autonomously or in a highly-automated manner, the time period since when the vehicle has been controlled by the autonomous vehicle controller or the highly-automated vehicle controller is also detected. These two pieces of information may be stored as a data pair in the memory unit of control device 2. In addition to the beginning of the autonomous or highly-automated driving, the point in time of the end of the autonomous or highly-automated driving may also be stored. Furthermore, it is also advantageous to store the information about the point in time at which the autonomous or highly-automated vehicle controller outputs a signal to the driver of the vehicle that the automatic vehicle controller is no longer capable of processing the upcoming driving situation and the driver has to take over the control of the vehicle. Such a takeover request to the driver has to take place in a timely manner and the driver has to take over the vehicle control within a maximum permitted time span upon this takeover request. It is therefore important to store the precise point in time of the output of the takeover request to the driver and to store the point in time at which the driver complies with the request and takes over the manual control of the vehicle again. These pieces of information are to be stored in the memory unit.

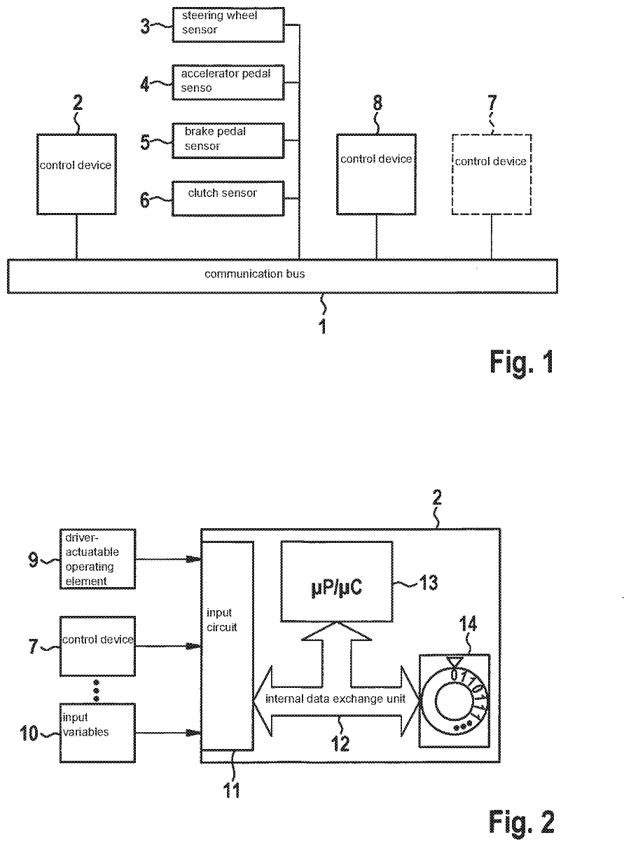

An exemplary embodiment of control device 2 for the sensor evaluation is shown in FIG. 2. Control device 2 has an input circuit 11, with the aid of which input variables may be supplied to control unit 2. Signals of driver-actuatable operating elements 9 are detected and supplied to input circuit 11 as one possible input variable. These driver-actuatable operating elements may be, for example, the sensors shown in FIG. 1 such as steering wheel sensor 3, accelerator pedal sensor 4, brake pedal sensor 5, and/or clutch sensor 6. With the aid of these signals, control device 2 may recognize whether the driver wishes to take over the vehicle control and, if a takeover request was output, at which point in time the driver takes over the vehicle control.

The output signal of a collision recognition unit 7 is supplied as a further input variable to input circuit 11. As described with respect to FIG. 1, this unit may be designed as an airbag control device, which recognizes a collision that has taken place, or may be designed as an evaluation unit of a surroundings detection unit, which recognizes objects in the vehicle surroundings and evaluates their relative velocity and movement direction and thus recognizes critical driving situations or collision situations which are already unavoidable and thus may output a collision recognition signal in the form of a warning signal to the driver before the collision point in time.

Furthermore, it is possible to supply further input variables 10 to input circuit 11. The signals of driver-actuatable operating elements 9 supplied to input circuit 11 are supplied via an internal data exchange unit 12 to a calculation unit 13, which may be designed, for example, as a microprocessor or microcontroller. It may be ascertained in this calculation unit 13 whether the driver presently actuates a driver-actuatable operating element, and also whether he has taken over the vehicle control himself. Furthermore, the input data of driver-actuatable operating elements 9 are relayed via the internal data exchange system to the memory unit 14, which is designed in particular as a ring buffer, and stored therein. If control unit 2 detects a signal of collision recognition unit 7 that a collision of the vehicle has taken place or a collision of the vehicle with an object in the surroundings is to take place soon, the data stored in memory unit 14 may thus be frozen, whereby subsequent changes and also deletion or overwriting of the data are prevented.

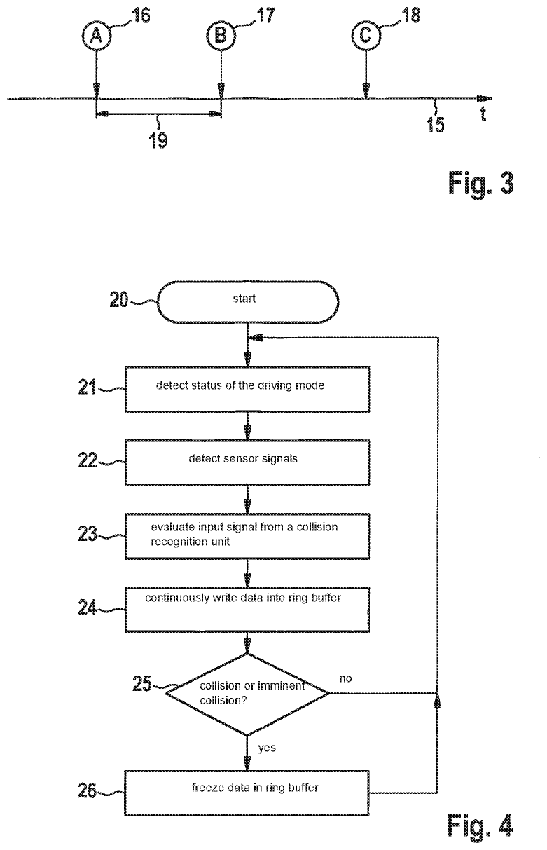

A timeline 15 of an exemplary collision situation is shown in FIG. 3. An event A is shown at point in time 16, at which the vehicle controller, which controls the vehicle autonomously or in a highly-automated manner, has output a takeover demand of the vehicle control by the driver (takeover request). In the further course of time, event B is shown at point in time 17, at which the driver has taken over the vehicle control by his manual intervention. This duration which was required between event A and event B may be referred to as takeover duration 19 and is of particular interest in the case of an accident reconstruction, since the takeover request has to be output in a timely manner before a possible collision point in time and the driver also has to have taken over the control within a maximum duration. At point in time 18, event C is shown, which represents the collision recognition by triggering of an occupant protection system. To enable accurate reconstruction of these data, it is necessary for the time data of various control devices 2, 7, 8 to have a shared time base. For this purpose, the timers of these control devices 2, 7, 8 have to be synchronized, for example, by a signal being provided on communication bus 1 which is used as a synchronization base. Alternatively, it is also possible that, for example, control device 2 for sensor evaluation outputs its time signal on the communication bus and other control devices 7, 8 synchronize with this time signal.

In the accident reconstruction, it is to be clarified whether the driver or the automatic vehicle control system had the control over the vehicle, three event points in time A, B, and C being evaluated for this purpose. For this purpose, it is necessary that the takeover signal of the automatic vehicle controller to the driver was not output excessively late. For example, the duration between event A 16 and event C 18 has to be at least two seconds. If this duration between event A and event C is excessively long, the takeover request thus comes excessively early, at which the acceptance of the automatic vehicle control by the driver decreases. Furthermore, the takeover of the vehicle control by the driver has to take place in a timely manner, since otherwise the driver is no longer able to avoid a collision. The duration between event B and event C is to be at least two seconds. If the driver takeover takes place excessively shortly before the collision recognition, the driver is thus no longer able to react and the driver thus may no longer be made liable for resulting damage. If the duration between event A and event C is more than two seconds and at the same time the duration between event B and event C is also greater than two seconds, the takeover request at point in time A by the automatic vehicle controller comes sufficiently early and the driver takes over the vehicle control in a timely manner.

If a collision according to event C is recognized by collision recognition unit 7, the data stored in the ring buffer are then frozen so that they may no longer be overwritten. Furthermore, a sequence of images of a possibly provided front camera of the vehicle may be stored with the collected pieces of information in memory unit 14. It is also possible to store further data from other sensors which are used for the autonomous driving or the highly-automated driving or which describe the collision situation. It is furthermore possible to store and freeze in memory unit 14 the last commands to relevant components of the autonomously driving vehicle or the vehicle driving in a highly-automated manner, such as signals to the engine control, the braking system, or the steering units.

Alternatively, control unit 2 may also be a partial function of control device 7 of the collision recognition unit or may be implemented in control device 8, which may be designed, for example, as a head unit or a main computer of an automated vehicle control system.

An exemplary flow chart is shown in FIG. 4, which begins in step 20. This starting step 20 may be executed when, for example, an automatic vehicle control system for a highly-automated vehicle control or an autonomous vehicle control is activated. It is alternatively also possible to execute this starting step 20 when the vehicle is started.

In subsequent step 21, the status of the driving mode is detected by establishing whether the vehicle is presently operated in an autonomous driving mode or a highly-automated driving mode or a manual operating mode.

This information may be represented, for example, as a status bit. In following step 22, sensor signals are detected, with the aid of which a driver activity is recognizable. Thus, for this purpose a steering wheel sensor 3, an accelerator pedal sensor 4, a brake pedal sensor 5, or a clutch sensor 6 may be evaluated for this purpose and it may be established whether the driver presently controls the vehicle or wishes to take over the vehicle control.

In following step 23, the input signal from a collision recognition unit is evaluated, with the aid of which it is established whether a collision has taken place or an unavoidable collision is imminent.

In following step 24, the data are written continuously into the ring buffer. If the memory of the ring buffer is full, the oldest stored data are thus overwritten using new data, so that the most up-to-date data are always stored in memory unit 14.

In step 25, the input signal of the collision recognition unit or the collision recognition signal of a surroundings sensor is evaluated and if a collision or an imminent collision is present, step 25 branches to yes and the sequence continues in step 26. If a collision has not taken place or a collision is not imminent, step 24 thus branches to no and the method is continued in step 21 by the status of the driving mode being detected again.

If a collision or an imminent collision is recognized in step 25, in following step 26, the data presently located in the ring buffer are thus frozen so that they are secured against updating, deletion, or modification. Alternatively, it is also possible that the data to be continuously stored in step 24 are written into a volatile memory, for example, also a ring buffer, and if a collision was recognized or an imminent collision situation was recognized in step 25, the data of the volatile memory are written into a nonvolatile memory and thus also protected against modification such as deletion, overwriting, or modification.

1-11. (canceled)

12. A device in a vehicle, which is controlled in an autonomous or highly-automated driving mode without intervention of a driver of the vehicle or in a manual driving mode by the driver of the vehicle, the device comprising:
a memory unit in which data are recorded, the data including at least include pieces of information as to whether the autonomous or highly-automated driving mode was active or the manual driving mode was active at a collision point in time or up to shortly before the collision point in time,
wherein the device is configured to evaluate sensor signals supplied to the device, with the aid of which it is recognized whether the driver actuates driver-actuatable operating element of the vehicle, and
wherein the device is configured to evaluate collision recognition signals supplied to the device, with the aid of which it is recognized whether an accident of the vehicle has taken place or is imminent.

13. The device as recited in claim 12, wherein sensors, whose sensor signals are supplied and with the aid of which it is recognized whether the driver actuates driver-actuatable operating elements of the vehicle, include one of the following: (a) a steering wheel sensor, or (b) an accelerator pedal sensor, or (c) a brake pedal sensor, or (d) a clutch sensor, or (e) any combination of (a)-(d).

14. The device as recited in claim 12, wherein the collision recognition signals supplied to the device, with the aid of which it is recognized whether an accident of the vehicle has taken place or is imminent, are: (i) signals from an airbag control device, which prompt freezing of present data in the memory unit upon triggering or partial triggering of an airbag, or (ii) signals of a surroundings sensor having collision recognition, which prompt freezing of the present data in the memory unit upon recognition of a collision situation which is no longer avoidable.

15. The device as recited in claim 12, wherein the memory unit is a ring buffer.

16. The device as recited in claim 12, wherein the device includes an evaluation device which evaluates the sensor signals and the collision recognition signals, and a collision recognition unit configured to recognize whether an accident of the vehicle has taken place or is imminent.

17. The device as recited in claim 16, wherein the evaluation device, the collision recognition unit, sensors that supply the sensor signals, and the memory are connected to one another by a communication bus.

18. The device as recited in claim 17, wherein timers in the evaluation device, in the sensors, in the collision recognition unit, and in the memory are synchronized with one another via the communication bus.

19. The device as recited in claim 12, wherein the data stored in the memory unit are stored with a timestamp.

20. A method for a vehicle, which is controlled in an autonomous or highly-automated driving mode without intervention of a driver of the vehicle or in a manual driving mode by the driver of the vehicle, the method comprising:
recording data in a memory unit, the data including at least pieces of information as to whether the autonomous or highly-automated driving mode was active or the manual driving mode was active at a collision point in time or up to shortly before the collision point in time;
evaluating sensor signals to recognize whether the driver actuates driver-actuatable operating elements of the vehicle; and
evaluating collision recognition signals to recognize whether an accident of the vehicle has taken place or is imminent.

21. The method as recited in claim 20, wherein sensors, which recognize whether the driver actuates driver-actuatable operating elements of the vehicle, include: (a) a steering wheel sensor, or (b) an accelerator pedal sensor, or (c) a brake pedal sensor, or (d) a clutch sensor, or (e) any combination of (a)-(d).

22. The method as recited in claim 20, wherein the pieces of information stored in the memory unit, which indicates whether the autonomous or highly-automated driving mode was active or the manual driving mode was active at a collision point in time or up to shortly before a collision point in time, is mapped as a status bit.

23. The method as recited in claim 22, wherein at least the status bit and a timestamp are stored when: (a) the autonomous or highly-automated driving mode is started, or (b) the autonomous or highly-automated driving mode is ended, or (c) the vehicle outputs the message to the driver during the autonomous or highly-automated driving mode that the driver is to take over the control of the vehicle, or (d) the driver actuates a driver-actuatable operating element of the vehicle, or (e) a collision recognition signal is recognized, that an accident of the vehicle has taken place or is imminent, or (f) any combination of (a)-(e).
